(19) United States
(12) Patent Application Publication
(10) Pub. No.: US 2022/0072761 A1
(43) Pub. Date: Mar. 10, 2022

(54) CELLULOSE-BASED ACETATE FILM LINED MOLDED FIBER ARTICLES AND METHODS OF MANUFACTURE

(71) Applicant: Sonoco Development Inc., Hartsville, SC (US)

(72) Inventor: ROBERT THOR VERSLUYS, FLORENCE, SC (US)

(21) Appl. No.: 17/014,440

(22) Filed: Sep. 8, 2020

(51) Int. Cl. B29C 51/16; B29C 51/04; B29C 51/00; B29C 51/26; B29C 51/20; B29C 51/42; B29C 51/10; B29B 11/14; D21H 11/12; D21H 11/16

(52) U.S. Cl. CPC B29C 51/165; B29C 51/04; B29C 51/002; B29C 51/263; B29C 51/20; B29L 2031/712; B29C 51/10; B29B 11/14; D21H 11/12; D21H 11/16; B29C 51/421

(57) ABSTRACT

The present disclosure is directed to recyclable lined molded fiber articles (e.g., bowls) that provide the necessary performance characteristics for storing frozen and refrigerated foods (acceptable oil resistance, water resistance, and water vapor barrier). The disclosed articles and methods for manufacturing such articles include bonding a thermoformable cellulose-based acetate film to a molded bagasse fiber article to form an impervious liner.

### FIELD OF THE DISCLOSURE

The present disclosure relates generally to food containers and more particularly to fiber-based food containers.

### BACKGROUND OF THE DISCLOSURE

For at least sustainability purposes, it is desirable to provide food packaging and containers which comprise materials other than plastic. In order to provide a viable alternative to plastic packaging, however, the container should have certain properties which are comparable to plastics in order to serve the purposes of food packaging and consumer acceptability.

Molded fiber articles may be used as an alternative to plastic packaging, but molded fiber does not inherently have oil resistance, water resistance and/or at least a moderate water vapor barrier, properties which are important in food packaging. While molded fiber does not inherently possess these attributes, the oil resistance and water resistance of molded fiber can be improved through the use of certain additives in the wet-end paper pulp. While these additives can create a package that moderately meets performance needs for frozen meals, the standard additives are not sufficiently able to provide the necessary performance for refrigerated meals. Furthermore, in order for the additives to adequately perform in containers used for frozen meals, a PFA oil and grease additive has commonly been included in such containers.

Per- and polyfluoroalkyl substances (“PFAs”) are a group of man-made chemicals that includes perfluorooctanoic acid, perfluorooctane sulfonate, GenX (2,3,3,3-tetrafluoro-2-(heptafluoropropoxy)propanoate (FRD-902) and heptafluoropropyl 1,2,2,2-tetrafluoroethyl ether), and many other chemicals. Studies have indicated that PFAs are very persistent in the environment and in the human body—meaning they don't break down and can accumulate over time. There is evidence that exposure to PFAs may lead to adverse human health effects. Thus, PFAs are currently being either banned or heavily scrutinized as health concerns.

Previous attempts to bond thermoplastic materials to contoured molded fiber articles have been met with issues such as melting or shrinking of the liner when exposed to high temperatures, browning or charring of the fiber when exposed to high temperatures, and importantly, the articles lined with such thermoplastic materials have not been sustainable—recyclable or compostable.

Therefore, the present invention focuses on a molded fiber article which meets sustainability and recyclability goals, provides enhanced performance properties for storing frozen and refrigerated foods (oil resistance, water resistance, and water vapor barrier), performs acceptably under high heat, and avoids the use of certain additives such as PFAs. The articles and methods for manufacturing such articles comprise bonding a thermoformable cellulose-based acetate film to a molded bagasse fiber article to form an impervious liner.

### SUMMARY OF THE DISCLOSURE

Generally speaking, the invention relates to a recyclable lined molded fiber article (e.g., bowl) for use with frozen and refrigerated foods with good oil resistance, water resistance and moderate water vapor barrier, while remaining free of any type of perfluoroalkoxy alkane (PFA). Specifically, the invention relates to bonding a thermoformable cellulose-based acetate film to a molded bagasse fiber article to form an impervious liner. Prior art additives in the wet-end fiber pulp cannot provide the necessary performance characteristics to the molded fiber article for storing refrigerated foods. Moreover, these prior art PFA oil and grease additives should be avoided due to health concerns. By using cellulose based acetate film, the lined molded fiber article avoids use of petroleum-based films while retaining service temperatures similar to polyethylene terephthalate (PET).

In an embodiment, the invention comprises a lined molded fiber article comprising a contoured body, thermoformed from an aqueous slurry comprising virgin bagasse fiber pulp, wherein the body includes one or more surfaces, and a cellulose-based acetate film liner bonded to at least one of the one or more surfaces of the body. The article may be impervious to at least one of oil and water. The cellulose-based acetate film liner may be a permeation barrier to at least one of water and oxygen and/or may be solvent cast. The fiber pulp may comprise 100% virgin bagasse fiber and/or may be depithed. The body of the article may include perforations. In an embodiment, the cellulose-based acetate film is cellulose di-acetate or cellulose tri-acetate. In an embodiment, the cellulose-based acetate film has a thickness within a range of about 1-5 mil and/or is a food-contact surface. In an embodiment, a layer of amorphous polyester is disposed between the cellulose-based acetate film liner and the one or more surfaces of the body to which it is bonded. In an embodiment, the article further comprises a barrier layer which may be disposed between the cellulose-based acetate film liner and the one or more surfaces of the body to which it is bonded. In an embodiment, the barrier layer comprises polyethylenimine (PEI).

In an embodiment, the invention comprises a method for manufacturing a cellulose-based acetate lined molded fiber article, the method comprising positioning the molded fiber article on an open-face suction die with a film-receiving surface of the molded fiber article facing away from the die, positioning the cellulose-based acetate film adjacent to and facing the film-receiving surface of the molded fiber article, rapidly preheating the cellulose-based acetate film, and using suction to cause the preheated cellulose-based acetate film to stretch and contact the film-receiving surface of the molded fiber article, such that the film bonds with one or more contours of the molded fiber article, thereby forming a liner on the film-receiving surface of the molded fiber article. In an embodiment, the method additionally comprising preheating the molded fiber article on the die, optionally via a heated die, to a preheat temperature after the positioning step. The preheat temperature of the molded fiber article may be within a range of about 300-375° F. In an embodiment, the suction step, which forms the liner on the molded fiber article, occurs in less than about 1 second. In an embodiment, the open-face die includes suction ports configured to apply suction through the molded fiber article. In an embodiment, the suction is applied at about 20 inHg. In an embodiment, the method additionally comprises mechanically pressing the film into contact with the film-receiving surface of the molded fiber article via a movable die. In an embodiment, rapidly preheating the film comprises heating the film to a bonding temperature, wherein the bonding temperature is above both a thermoformable temperature and a crystallization temperature of the film. In an embodiment, the bonding temperature is within a range of about 350-500° F. In an embodiment, the rapid preheat time for the film is within a range of about 1-3 seconds.

The accompanying drawings, which are incorporated in and constitute a part of this specification, illustrate one or more embodiments of the present disclosure and, together with the description, serve to explain the principles of the present disclosure.

### BRIEF DESCRIPTION OF THE DRAWINGS

A full and enabling disclosure directed to one of ordinary skill in the art, is set forth in the specification, which makes reference to the appended drawings, in which:

FIG. 1 illustrates an embodiment of a contoured container body of the invention;

FIG. 2 illustrates an embodiment of a contoured container body of the invention;

FIG. 3 is an enlarged fragmentary sectional elevational view, with the scale exaggerated for purposes of clarity, showing an embodiment of a contoured body of a molded fiber article of the invention; and

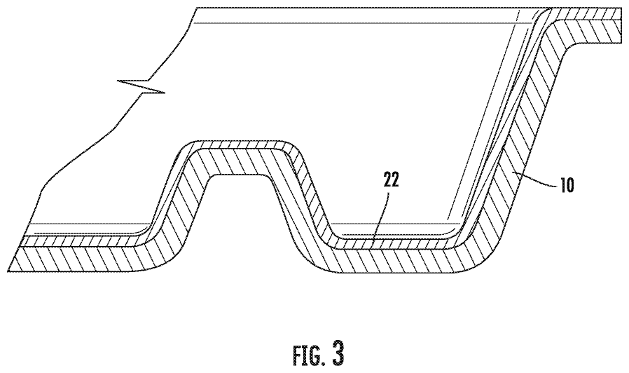

FIG. 4 is a schematic sectional elevational view, with the scale exaggerated, illustrating an embodiment of an apparatus for forming the invention.

Repeated use of reference characters in the present specification and drawings is intended to represent the same or analogous features or elements of the present disclosure.

### DETAILED DESCRIPTION

Reference will now be made in detail to embodiments of the present disclosure, one or more examples of which are illustrated in the accompanying drawings. Each example is provided by way of explanation of the present disclosure, not limitation of the present disclosure. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

In an embodiment, the invention provides a lined fiber-based container for food products (raw or cooked, frozen or refrigerated) that are heated and/or reheated directly in the container. In some cases, the containers are referred to as ‘ovenable,’ as in capable of being reheated in an oven, microwave, or other heating mechanism. The containers of the invention may be used in connection with any type of product, however, regardless of whether it is a food or non-food product.

The film that is applied to the contoured body of the molded fiber article to form a liner may be a cellulose-based acetate film. In some embodiments, the film may be a derivative of cellulose acetate (e.g., cellulose di-acetate or cellulose tri-acetate). In an embodiment, the film is solvent cast (as opposed to being formed via forced extrusion), which may aid in providing clarity and improved surface quality. Optionally, the film may be pigmented and/or may have a matte finish. The cellulose-based acetate film utilized herein is thermoformable and may have a melting point of about 225° F.

In other embodiments, the film may comprise polyethylene terephthalate (PET), and may optionally be oriented (OPET) or may comprise a cast film. In an embodiment, the PET may have performance enhancing layers such as metallization, polyvinylidene chloride (PVDC) barrier coatings, primers or heat seal coatings. In still other embodiments, the film may comprise polypropylene (PP), as a blown or cast film. In this embodiment, the PP film may have multiple layers or may have outer coatings to enhance performance, such as metallization, PVDC barrier coatings, primers or heat seal coatings.

In an embodiment, the film may comprise a multilayer polyolefin cast or blown films, including polyethyene-like resins such as low density polyethylene (LDPE), linear low density polyethylene (LLDPE), high density polyethylene (HDPE), ethylene vinyl acetate (EVA), ethylene vinyl alcohol (EVOH), polyvinyl alcohol (PVOH), ionomers, and metallocenes, optionally in separate layers to produce desired performance. In an embodiment, the film may comprise nylon or polyamide (PA) films, and may be blown, cast or oriented (OPA). PA films may also have performance enhancing layers such as metallization, PVDC barrier coatings, primers or heat seal coatings. In other embodiments, the film may comprise PLA or poly-lactic acid, polybutyl succinate, bio-polyesters and other films produced from compostable resin or resin combinations. These films may be blown, cast or oriented.

In an embodiment, the film of the invention may be in the range of about 1-5 mils in thickness. In another embodiment, the film of the invention may be in the range of about 50 μm to 100 μm in thickness. In a particular embodiment, the film of the invention may be about 1.5 mil in thickness. In another embodiment, the film of the invention may be greater than about 2 mil in thickness. In an embodiment, the amorphous polyester and/or polyethyleneimine (PEI) are applied via a gravure coating operation onto the film or the article body.

In an embodiment, the film itself may serve as a permeation barrier to water and/or oxygen. Optionally, in an embodiment, the film may be provided with an additional barrier coating which may provide a permeation barrier to water and/or oxygen. Alternatively, a barrier coating may be applied to the finished article of the invention. In some embodiments, the barrier coating may be applied to the contoured body of the molded fiber article or to the film-receiving surface of the molded fiber article, each before film liner is applied. The barrier coating may comprise, for example, polyethylenimine (PEI). In an embodiment, the film may be metalized, may have received a vapor deposition chemistry to improve its barrier to water and/or oxygen, and/or may serve as a receptor film for microwave cooking/heating.

In an embodiment, the film may have a body-facing surface and an exterior-facing surface, opposite to the body-facing surface. The body-facing surface of the film may face the contoured body of the molded fiber article during application of the liner. In an embodiment, the exterior-facing surface may comprise a food-facing surface of the film liner.

In an embodiment, the body-facing surface of the film may comprise a film, layer, or coating which may increase adhesion between the body-facing surface of the film and the film-receiving surface of the contoured body of the molded fiber article. In an embodiment, the adhesion-improving composition may comprise a heat-sealable material. In an embodiment, the adhesion-improving composition may comprise amorphous polyester. In another embodiment, the film-receiving surface of the molded fiber article may comprise a film, layer, or coating which may increase adhesion between the body-facing surface of the film and the film-receiving surface of the contoured body of the molded fiber article. In an embodiment, this coating may be heat-sealable and/or may comprise amorphous polyester. In an embodiment, the adhesion-improving composition may be applied to the film-receiving surface of the contoured body of the molded fiber article at a thickness within the range of about 3-6 mil (about 76-153 μm). In some embodiments, the heat-sealable coating may be sprayed on or otherwise applied to the film-receiving surface of the contoured body of the molded fiber article or the body-facing surface of the film. In an embodiment, the adhesion-improving composition may also provide a permeation barrier to water and/or oxygen. Other coatings which may increase adhesion may be utilized in this embodiment.

The invention utilizes a pulp slurry in forming the molded fiber articles. Optionally, the pulping process may be conducted at low temperatures, without high pressure tanks, thereby using significantly less energy and between ⅛th and 1/10th the water of a traditional wood pulping process. In addition, such a pulping process may be sulfur free, may produce minimal solid waste, and any of such solid waste may be recycled.

The lined fiber-based container is described herein as being formed via a Type III thermoforming molded fiber process, but it should be understood that any molded fiber process known in the art may be utilized. Type III thermoforming of molded fiber generally results in a thin-walled article and consists of two main steps—1) wet end forming of the part; and 2) hot end pressing of the part. Wet end forming comprises making a fiber slurry from ground fiber suspended or dispersed in water with additional ingredients. A mold is dipped or submerged in the slurry and a vacuum is applied. The vacuum pulls the slurry onto the mold to form the shape of the container. While still under the vacuum, the mold is removed from the slurry tank, allowing the water to drain from the pulp. Hot end pressing involves then capturing the form in heated molds where it is pressed, densified and dried. In an embodiment of the invention, hot pressing may occur before or during application of a film to a film-receiving surface of the contoured body of the molded fiber article that is formed.

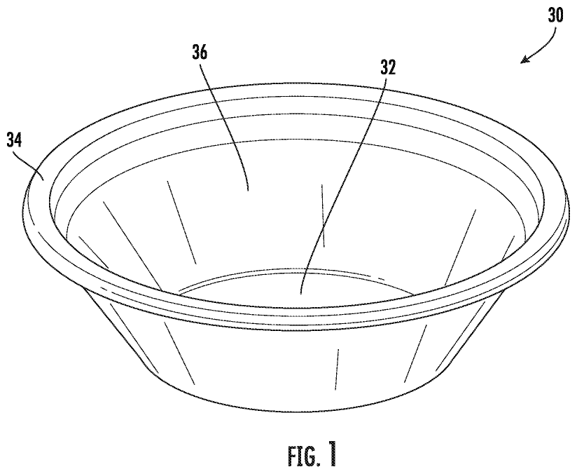

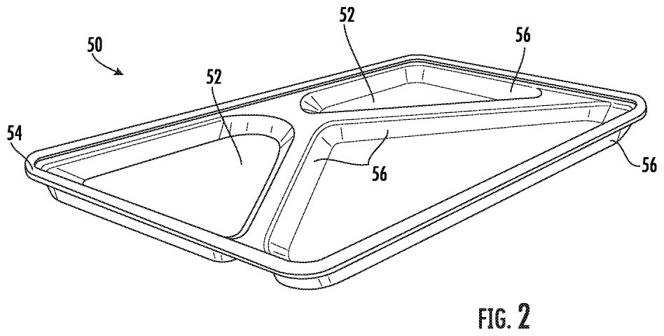

Purely representative products according to this invention are illustrated in FIGS. 1 and 2. FIG. 1 is a perspective view of a relatively simple food serving bowl 30 having a horizontal base wall portion 32, a circumferential rim or flange wall portion 34, and sloping side wall portions 36.

Likewise, FIG. 2 illustrates a perspective view of a food serving tray 50 having a horizontal base wall portion 52, a circumferential rim or flange wall portion 54, and sloping side wall portions 56.

The process of the present invention begins with the formation of a slurry comprising fiber pulp and water. The source of the paper pulp may comprise bagasse, softwood, bamboo, sugarcane, eucalyptus, wheat, straw, corn, newsprint, old corrugated containers, wood, or any other commercially available type of paper stock, including paper mill sludge or any combination of fiber sources. The pulp may be virgin or recycled. In a particular embodiment, the paper pulp comprises 100% bagasse. In a particular embodiment, the paper pulp comprises 100% virgin bagasse. In an embodiment, the virgin bagasse may be depithed to remove the shortest fibers. In such embodiment, the average fiber length may be increased (e.g., to about 1.01 mm) to improve dewatering rates, pulp yield, tear strength, and/or water retention value of aqueous slurry.

In an embodiment, one or more additives may be added to the slurry during the wet phase of the process. For example, a sizing agent may be added to the slurry. In an embodiment, the sizing agent may comprise alkyl ketene dimer (AKD). However, any sizing agent know in the art may be utilized. In an embodiment, the sizing agent may comprise an aqueous emulsion of AKD. In an embodiment, the sizing agent may be cationic. In an embodiment, the sizing agent may have an affinity for cellulose fibers. In an embodiment, the sizing agent is hydrophobic. In an embodiment, the sizing agent has a low viscosity. In an embodiment, the AKD is added in an amount between about 1 and about 3 lbs active/dry ton of fiber.

In an embodiment, a dry strength additive is added to the slurry. In an embodiment, the dry strength additive may be a polyvinylamine copolymer polymer. However, any dry strength additive known in the art may be utilized. In an embodiment, the dry strength additive is non-starch. In an embodiment, the dry strength additive is added in an amount between about 1 and about 5 lbs active/dry ton of fiber.

In a further embodiment, a retention and/or drainage aid may be added to the slurry. In an embodiment, the retention/drainage aid may comprise an anionic organic polymer. In an embodiment, the retention/drainage aid may have a three-dimensional shape. In an embodiment, the retention/drainage aid may be semi-polar. In an embodiment, the retention/drainage aid may be added in an amount between about 1 and about 5 lbs active/dry ton of fiber.

The temperature of the slurry may be provided at ambient temperatures, in some embodiments. In other embodiments, the temperature of the slurry may be kept above ambient temperatures to reduce viscosity and aid in depositing the pulp on the forming mold. Warmer water may also aid in swelling the fibers, causing them to break apart. In a particular embodiment, the temperature of the water may be between about 100° and 150° F. Upon stirring, the fibers may become unbound and become a pulp slurry.

In an embodiment, a hydropulper may be utilized to form the slurry. In this embodiment, the fiber may be mixed with water and optionally de-fibred to form a pulp. Impurities may be filtered out. The pulp may then be pumped into a forming line, in an embodiment.

A forming mold is then immersed into the slurry and a vacuum is applied to the forming mold. Alternatively, the slurry may be poured into a mold under vacuum. The forming mold may be of the same general configuration as the desired finished product. The forming mold may comprise wire, mesh, plastic, metal, or any other material known in the art which allows water to pass therethrough, but retains the pulp material thereon. In an embodiment, the mold is configured such that the resulting molded fiber article will have a three-dimensional shape and/or will be contoured. For example, the contoured body of the molded fiber article may comprise a bowl having a base portion, at least one upwardly extending wall, and a rim portion. One or more ridges may be disposed along the sidewall or rim of the bowl. Likewise, the contoured body of the molded fiber article may comprise a tray or plate having one or more compartments. The compartments may be divided by raised areas and/or the tray or plate may be circumvented by a rim. The mold may be configured to form such a bowl, tray, plate, or any other contoured article known in the art.

In an embodiment, the mold comprises an open-face suction mold. The amount of vacuum to be used to cause the deposition of the paper pulp onto the forming mold will depend on process considerations such as the temperature of the water in the slurry, the type of paper pulp provided in the slurry, and the product being produced. The vacuum may be applied underneath the mold, in an embodiment.

In an embodiment, once a layer of wet paper pulp has built up upon the forming mold at the desired thickness, the forming mold may be removed from the slurry (optionally while still under vacuum) and optionally transferred to a female pressing die, optionally heated, having a cavity formed therein. The die cavity may be provided in a configuration which is similar to that of the finished product molded fiber article to be produced. In an embodiment, the wet paper pulp is transferred into the cavity in a manner such that the walls of the wet pulp container are in substantial alignment with the walls of the cavity. That is, the layer of wet paper pulp is deposited into the cavity of the female pressing die in such a manner that the layer of wet paper pulp contacts with the walls of the cavity along the length thereof.

Alternatively or additionally, the forming mold itself may comprise a heated press. In this case, no transfer may be necessary and the vacuum may be maintained during an optional heated pressing process (prior to application of the liner). In an embodiment, the inventive process also utilizes a male pressing die, optionally also heated. The male pressing die may be pressed into the mold prior to application of the film in an embodiment, squeezing out any excess water, imparting a final shape and particular finish to the container, densifying the container, at least partially heating and drying the container, and/or at least partially curing the container. In this embodiment, the male pressing member may be inserted into the cavity in such a manner that the layer of wet pulp is confined and compressed between the walls of the female pressing die cavity and the male pressing member. The male pressing member may be operated by any conventional source, such as pneumatic or hydraulic pressure, and is extendible into and retractable from the female pressing die cavity. The male pressing member may be provided in the form of the finished product molded fiber article and by application of pressure and heat to the layer of wet paper pulp from the male pressing die, the layer of wet paper pulp is molded into the shape of the product molded fiber article while being constrained in the female pressing die cavity.

In an embodiment, the molded fiber article may be perforated during forming and/or after formation but prior to application of the film liner. This may be accomplished via any process known in the art. In an embodiment, the perforations may be formed by providing needle-like projections on the contact surface of one or both of the male or female press, such that when the molded fiber article is contacted with and pressed into the relevant press, the needles project through the molded fiber article and form perforations. In other embodiments, a water jet may be used during the formation process to create perforations or thinned areas of the article. The water jet would be protected toward one or more surfaces of the article to create the perforations or thinned areas.

As noted, alternatively or additionally, the walls of the molded fiber article may be selectively thinned and/or the density of such walls may be reduced during forming. This may be accomplished using any method known in the art. In an embodiment, the density of the article may be reduced by increasing the gap between the forming tools such that they are not as closely positioned during the pressing process. This can be accomplished throughout the entire press or only in designated areas. The walls may be thinned, in an embodiment, by decreasing the gap between the forming tools such that they are positioned more closely during the pressing process. Alternatively, the forming tool (i.e. mesh) could have a decreased porosity so that it accumulates less fiber during the forming process. The decreased porosity of the forming tool could be accomplished throughout the entire tool or only in designated areas. In an embodiment, the density of the molded fiber article may be between about 0.65 g/cm³ and about 0.85 g/cm³.

In an embodiment, any of the above processes may result in the one or more film-receiving surfaces of the contoured body of the molded fiber article having an increased porosity, which may increase the adhesion of the cellulose-based acetate film to the one or more film-receiving surfaces by allowing faster forming of the film during the film application process.

In an embodiment, both the female and the male pressing dies may comprise heated dies. The heated pressing step, if utilized prior to application of the film to the molded fiber article, may be conducted under a heating temperature of between about 100° C. and 250° C. and a pressing time of 5-200 seconds, in an embodiment.

In the next step, the film is bonded to the molded fiber article. Generally speaking this process comprises pre-heating the molded fiber article obtained in the manner explained above, rapidly pre-heating a cellulose acetate film, and then bonding the film to the film-receiving surface of the contoured body of the molded fiber article via hot pressing the pre-heated film into contact with the surface of the pre-heated base and/or vacuum suctioning the pre-heated film into contact with the surface of the pre-heated base. The bonding step occurs at a temperature and for a time which ensures that the film is stretched into direct contact with the contoured body of the molded fiber article and becomes directly bonded thereto. In some embodiments in which the film and/or contoured body have been coated with an adhesion-improving layer, the film is stretched into indirect contact with the film-receiving surface of the contoured body of the molded fiber article, and becomes indirectly bonded thereto. In an embodiment, the bonded liner forms a contiguous and integral liner.

In some embodiments, the molded fiber article may include an upper or top surface and a lower or bottom surface, where the upper surface is the film-receiving surface to be lined by the film. In an embodiment, the female mold (or pressing die) is disposed to support the molded fiber article and is positioned at the surface of the article which is not designed to receive and bond to the liner. In an embodiment, this may comprise the bottom surface of a container, such as a bowl or tray, for example. This female mold may be heated to facilitate better bonding between the article and the film.

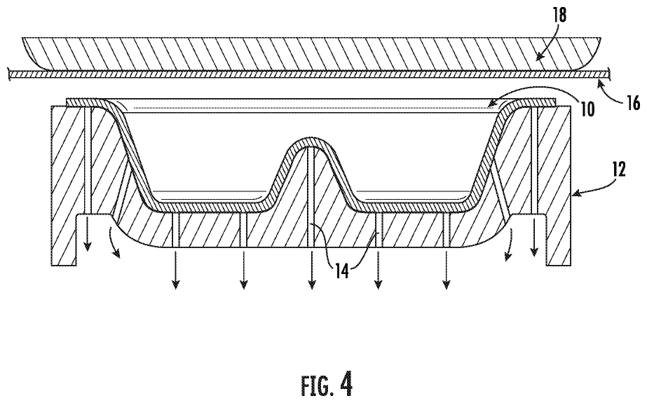

Referring to FIG. 4, in an embodiment, the die 12 is made with suction ports 14 connected with a source of vacuum (not shown) so that suction can be applied through the molded fiber article 10 during the bonding steps of the process. Preferably, the vacuum applied is in the range of about twenty inches of mercury, although lower values will be suitable for the shallower contoured articles and/or thinner films and higher values may be advisable for the deeper contoured articles and/or thicker films.

In an embodiment, the die 12 is heated by conventional heating means (not shown) at a temperature in the range of between about 300° F. and about 600° F. The appropriate temperature is selected within this range to ensure that the molded fiber article will be pre-heated to a temperature such that the surface to receive the film is in the range between about 300° F. and about 375° F. In an embodiment, the surface in contact with the heated die (opposite the film-receiving surface) may attain higher temperatures. If the molded fiber article is relatively thick, and/or if it has a relatively intricately and/or deeply contoured shape, pre-heating to higher temperatures may be indicated. Articles having thinner bases, with relatively simply and shallowly contoured shapes may permit pre-heating temperatures in the lower end of the range.

The film 16 also is pre-heated in an embodiment. The film 16 is then placed in position, adjacent the film-receiving surface(s) of the molded fiber article 10. Because the film should be pre-heated rapidly and then quickly pressed against the base, it is recommended that the film be positioned with respect to the article before or as part of the pre-heating step.

The film can be pre-heated in any suitable manner known in the art. The film 16 should be heated above both the temperature at which it becomes thermoformable and the temperature at which it starts to crystallize. In an embodiment, the pre-heating step occurs in a relatively short time. In a particular embodiment, the film 16 is placed into contact with a plate 18, which may be coated with a material such as Teflon simply to ensure that the film 16 does not stick to the plate 18. The plate 18 may be heated by suitable heating means (not shown) to a temperature in the range between about 300° F. and about 400° F. In another embodiment, the plate 18 may be heated by suitable heating means (not shown) to a temperature in the range between about 250° F. and about 400° F. In still another embodiment, the plate 18 may be heated by suitable heating means (not shown) to a temperature in the range between about 325° F. and about 400° F. In still another embodiment, the plate 18 may be heated by suitable heating means (not shown) to a temperature in the range between about 356° F. and about 410° F.

The particular temperature within this range may be selected based upon the thickness of the film. Thicker film (i.e. with a thickness up to about 7.0 mil) may require that the plate 18 be maintained at a higher temperature within the range, or that the film be held in contact with the plate for a longer period of time. Thinner film (i.e. with a thickness close to approximately 1 mil) may be pre-heated rapidly to the requisite bonding temperature by contact with a plate maintained at a lower temperature within the range.

As noted, the film should be pre-heated rapidly, at least during that portion of the pre-heating which is in the temperature range in which the cellulose-based acetate film crystallizes. For instance, with film having a thickness of between about 0.5 mil and about 2.0 mil, the film is pre-heated from room temperature to the bonding temperature in a period of time which does not exceed about 2 seconds.

Once the film has been pre-heated to the desired temperature, vacuum is quickly is applied through the base 10 to suction the film into contact with the surface or surfaces of the article which are desired to be lined. The film is stretched into direct contact with the contoured article, and the film becomes thinned in areas and to extents as determined by the shapes and depths of the contours of the article. Continued application of suction induced by the vacuum ensures that the film becomes directly bonded to the exposed surface or surfaces of the molded fiber article so as to form a contiguous and integral liner 22 on the molded fiber article 10.

If desired, the film can be suction-applied against additional sides of the molded fiber article, such as the undersurface of the marginal rim or flange of the molded fiber article. Similarly, the step of contacting the film with the film-receiving surface of the molded fiber article may include super-atmospheric or mechanical pressing instead of or in addition to vacuum suction, such as by a movable male die designed to mechanically press the film against the film-receiving surface of the molded fiber article. Likewise, the film may be mechanically pressed against only one surface or only a portion of one surface of the molded fiber article, in certain embodiments. In certain embodiments, the molded fiber article and/or the film may contain printing for decorative, informative and other purposes.

The contact step (via vacuum suction and/or mechanical pressing) of the process is maintained for a time, such as several seconds or less, to ensure a proper physical bond between the film and the molded fiber article. It has been found that when the base and the film have been pre-heated in the manner explained herein, and the film is suctioned into the base by vacuum in the range of about 20 inches of mercury, a strong, mechanically inter-locking bond between the film and the molded fiber article can be attained in less than about 1 second.

If mechanical pressing or the use of super-atmospheric pressure is employed, the time required to obtain a suitable bond may be shorter, as can be understood.

In a final step, the formed container may be removed from the heated press mold. In order to aid in the removal of the finished product from the female pressing die cavity, the female pressing die may be made of separable halves, in order to facilitate the release of articles with negative release angles, sharp curves or abrupt changes in surface orientation. The separable halves may be joined together during the pressing step and separated from each other to release the finished product. In an embodiment, the container is ejected from the mold in its final state.

In an embodiment, the article is then cooled to room temperature. Liner and our pulp waste may optionally be trimmed to produce the final product.

A final heat annealing step may prove useful to further crystallize the liner, improving its properties for certain end uses. This step may comprise exposing the finished product to a temperature in the range between about 250° F. and about 400° F. for several minutes or more.

In an embodiment a coating is applied to the final product after ejection from the mold in its final state. In this embodiment, the coating may comprise an oil, moisture, and/or water vapor barrier. In an embodiment, the coating may comprise a water-based acrylic copolymer. In an embodiment, the coating is sprayed onto the final product. In other embodiments, the coating is printed onto the container or the container may be dipped in the coating. In yet another embodiment, a polymer film is vacuum drawn under heat into the final product.

In an embodiment, the coating is applied such that the container has a dry coat weight of between about 20 gsm and 180 gsm. In a particular embodiment, the container may have a dry coat weight of less than about 90 gsm. In another embodiment, the container may have a dry coat weight of about 50 gsm or less. In an embodiment, the coating may comprise between about 3% and about 20% of the final container weight. In another embodiment, the coating comprises, on a by weight percentage basis, about 15% of the container weight. In still another embodiment, the coating comprises about 10% of the container, by weight. In yet another embodiment, the coating comprises about 5% to about 20% of the container, by weight.

In an embodiment, the coating has a relatively high surface tension. In one embodiment, the surface tension of the coating may be between about 40 mN/mm and about 59 mN/mm. In another embodiment, the surface tension of the coating may be between about 35 mN/mm and about 38 mN/mm. The surface tension of the coating may be measured using a bubble pressure tensiometer with time lapse measurements, in an embodiment. In an embodiment, surfactants are used in the coating to lower the surface tension of the droplets of the coating and to enable coalescence/film forming on the molded fiber surface. In an embodiment, the surfactant requires a certain amount of time to migrate to the surface of the droplets (also referred to as “blooming”). In an embodiment, this migration occurs “in-flight”—i.e. during the spraying process—to maximize the film forming potential of the coating. The time in flight is controlled by the spray system setup and, in an embodiment, may be approximately 100 msec. In an embodiment, the surfactant blooms quickly enough to maintain the surface tension within the wetting envelope relative to the slope of the Cobb curve.

In an embodiment, dynamic surface tension does not increase more than 10% during spray application of the coating. In an embodiment, the atomization process reduces the water content of the coating by less than about 35% and maintains a dynamic surface tension within about 20% of the pre-atomized value. In an embodiment, the coating is applied using a low-atomization spray system. In an embodiment, the resultant interfacial tension between the sprayed coating and the pulp surface is less than about 15 mN/mm. In another embodiment, the resultant interfacial tension between the sprayed coating and the pulp surface is less than about 5.3 mN/mm. In still another embodiment, the resultant interfacial tension is less than 1.0 mN/mm. In an embodiment, the interfacial tension is calculated using an expansion of the Fowkes equation. In an embodiment, heavier coat weights are utilized to achieve full film formation at higher interfacial tension levels.

In an embodiment, the coating contains organic polymers. In an embodiment, the coating is highly polar relative to the paper substrate. In an embodiment, the coating has a dispersive/polar composition of 51%/49%. In another embodiment, the coating has a dispersive/polar composition of 53%/47%. In yet another embodiment, the coating has a dispersive/polar composition of 66%/34%. In still another embodiment, the coating has a dispersive/polar composition of 50%/50%.

In an embodiment, the molded fiber surface has a surface tension between 30 mN/mm and 60 mN/mm, with a ratio of disperse to polar of about 30:1 to about 40:1. In an embodiment, the inventive composition has a liquid resistance comparable to typical plastic articles. Both water vapor transmission and liquid water resistance are important properties of the inventive container. Water vapor transmission rate (WVTR) aids in providing an adequate shelf life for both frozen and refrigerated food containers. Liquid water resistance provides adequate shelf life for refrigerated meals as well as plays a part in resisting stains during meal reheating. Stained bowls are undesirable to consumers and inhibit end-of-life recycling options. Thus, in an embodiment, the container of the invention has an adequate WVTR and liquid water resistance.

In an embodiment, the coating may contain one or more additives that modify surface tension and/or shift the dispersive to polar ratio. In some embodiments, additives may comprise polyethylene glycol (“PEG”), polypropylene glycol (“PPG”), glycerin, and/or other polyglycols known in the art. In an embodiment, the coating may comprise one or more surfactants. Any surfactants known in the art may be utilized in this embodiment. In an embodiment, the coating may comprise one or more oils, emulsified oils, vegetable oils, and/or silicone oils.

In an embodiment, the coating has an approximately equivalent surface energy and surface tension, which may minimize the interfacial tension and provide consistent pinhole-free coatings. Low interfacial tension encourages coating droplets to spread out on the paper surface, join together and create a desirable uniform film layer of coating.

When an interface exists between a liquid and a solid, the angle between the surface of the liquid and the outline of the contact surface is described as the contact angle θ. The contact angle (also known as wetting angle) is a measure of the wettability of a solid by a liquid. In some embodiments, the contact angle of the coating on polytetrafluoroethylene (“PTFE”) is between about 78° and about 87°. In another embodiment, the contact angle of the coating on PTFE is between about 85° and about 87°.

In an embodiment, the invention must maintain a good degree of water hold-out (low absorbancy or Cobb value) in order to maintain the coating on the container surface so that it can form a continuous film. Low Cobb values, however, correspond to low surface energies that are highly dispersive. Both the low surface energy and having a very high dispersive component make it difficult to achieve film formation with a water-based coating. Hence, the Cobb value and surface energy must be balanced (they are inversely related). The polar component of the surface energy can be increased without significantly affecting the Cobb value.

While it is generally known that a higher surface energy (lower contact angle) allows for better wet-out of water-based coatings, the inventors have surprisingly discovered that AKD may be a key controller of the surface energy. In contrast, AKD is typically used to control the water hold-out of the paper (measured by the Cobb value).

In an embodiment, the water absorptiveness (Cobb value) of the container after two (2) minutes is between about 30 gsm and about 70 gsm. In an embodiment, the added AKD may balance the coating's hold-out (ability to be maintained on the surface of the substrate) and wet-out (ability to flow and cover a surface). In an embodiment, the container has a surface free energy between about 25 and about 55 dynes, with a ratio of disperse to polar of about 30:1 to 60:1.

This highly dispersive surface is not favorable for low interfacial tension of suitable water-based coatings. The inventors have discovered that by increasing certain non-AKD components, the dispersive to polar ratio can be reduced, thus lowering interfacial tension and facilitation consistent and reliable coalescence. These non-AKD components may improve drainage, increase retention and/or provide a greater strength, but due to their polar characteristics they can serve to additionally modify the paper surface characteristics in a way that improves its ability to be coated without compromising the Cobb values.

In an embodiment, the inventive composition does not contain AKD as an additive. In an embodiment, AKD is an additive in the slurry, but does not contribute to the liquid water resistance because the coating provides a pinhole-free surface. Thus, the AKD sizing agent does not contact the food product and/or have the ability to contribute to liquid water resistance. In an embodiment, the primary purpose of the AKD in the slurry is to create a particular surface chemistry which allows the coating to coalesce and provide a pinhole-free surface.

In an embodiment, the inventive container is fluorocarbon free. In an embodiment, the inventive container is PFA-free. In an embodiment, the inventive container does not contain liquid starch, colorants or dyes. In an embodiment, the fiber freeness level of the resultant container is between about 250 and 500.

In an embodiment, the various components and processes provide a molded fiber container having an inner surface which is optimized for the cellulose-based acetate film liner described herein. The surface roughness of the inventive container may be less than about 12 Ra using a stylus-style roughness measurement (technique 2).

In an embodiment, the weight of the inventive container may be between about 15 grams and about 25 grams. In another embodiment, the weight of the inventive container may be between about 17 grams and about 22 grams. In a particular embodiment, the weight of a container to be utilized with refrigerated foods may be between about 20 and about 22 grams. In yet another particular embodiment, the weight of a container to be utilized with frozen foods may be between about 17 and about 20 grams.

As discussed above, the methods of the present disclosure can be used to provide molded paper articles of any desired configuration. That is, many articles made of plastic that are currently vacuum-formed or injection-molded can be made from paper using the process of the present disclosure.

It is believed that the combination of the raw materials used in the articles of the invention in combination with the specific methods set forth herein impart superior performance characteristics of the resulting articles. In an embodiment, the articles of the invention can withstand service temperatures equivalent to those utilized in PET-based applications. For example, the articles of the invention may withstand service temperatures upward of 400° F. In some embodiments, the articles of the invention may withstand service temperatures upward of 450° F. In certain embodiments, the articles of the invention may be able to withstand such service temperatures for between fifteen and forty-five minutes. In other embodiments, the articles of the invention may be able to withstand such service temperatures for upward of forty-five minutes.

In embodiments, the articles of the invention are ovenable and microwavable. In an embodiment, the articles of the invention are food-safe. In an embodiment, the molded fiber article of the invention will not brown significantly or char when exposed to appropriate service temperatures. In embodiments, the film liner will not melt, shrink or separate from the contoured article itself under high heat conditions. In an embodiment, the inventive container may be useful for ready-to-heat and/or ready-to-cook containers. The container may contain raw or pre-cooked refrigerated or frozen foods, in an embodiment.

In certain embodiments, the articles of the invention are free of PFAs, and/or petroleum. In some embodiments, the articles of the invention are compostable and/or recyclable. In embodiments, the articles of the invention comprise inexpensive, disposable containers which are three-dimensionally contoured. In an embodiment, the film liner of the invention is applied without pleats or folds.

In an embodiment, the lined article of the invention provides a satisfactory barrier to oil, water, and water vapor. For example, laboratory testing of the lined article produced the following results (see Table 1).

TABLE 1

| | WVTR | 30 min Oil | 30 min Water |
|---|---|---|---|
| | (g/100 sq in/ | Penetration | Penetration |
| | day @ 23 C./ | (grams/square | (grams/square |
| | 90% RH) | meter) | meter) |
| 100 μm Cellulose | 3.1 | <1 | <1 |
| Acetate/0.55 mm fiber bowl | | | |
| (inventive composition) | | | |
| 50 μm PET/0.55 mm fiber | 0.9 | <1 | <1 |
| bowl | | | |
| 0.55 mm fiber bowl | 80 | >50 | >50 |

As can be seen, the inventive composition had an acceptable water vapor transmission rate (WVTR), oil penetration, and water penetration. The WVTR, oil penetration, and water penetration characteristics were similar to that of a PET-lined bowl and significantly improved over an unlined bowl.

Many modifications and other embodiments of the present disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A lined molded fiber article comprising:
a contoured body, thermoformed from an aqueous slurry comprising virgin bagasse fiber pulp, wherein the body includes one or more surfaces; and
a cellulose-based acetate film liner bonded to at least one of the one or more surfaces of the body.

2. The lined molded fiber article of claim 1, wherein the cellulose-based acetate film liner is impervious to at least one of oil and water.

3. The lined molded fiber article of claim 1, wherein the cellulose-based acetate film liner is a permeation barrier to at least one of water and oxygen.

4. The lined molded fiber article of claim 1, wherein the cellulose-based acetate film is solvent cast.

5. The lined molded fiber article of claim 1, wherein the fiber pulp comprises 100% virgin bagasse fiber.

6. The lined molded fiber article of claim 1, wherein the virgin bagasse fiber pulp is depithed.

7. The lined molded fiber article of claim 1, wherein the body includes perforations.

8. The lined molded fiber article of claim 1, wherein the cellulose-based acetate film is cellulose di-acetate.

9. The lined molded fiber article of claim 1, wherein the cellulose-based acetate film is cellulose tri-acetate.

10. The lined molded fiber article of claim 1, wherein the cellulose-based acetate film has a thickness within a range of about 1-5 mil.

11. The lined molded fiber article of claim 1, wherein the cellulose-based acetate film liner comprises a food-contact surface.

12. The lined molded fiber article of claim 1, wherein a layer of amorphous polyester is disposed between the cellulose-based acetate film liner and the one or more surfaces of the body to which it is bonded.

13. The lined molded fiber article of claim 1 further comprising a barrier layer.

14. The lined molded fiber article of claim 13, wherein the barrier layer is disposed between the cellulose-based acetate film liner and the one or more surfaces of the body to which it is bonded.

15. The lined molded fiber article of claim 13, wherein the barrier layer comprises polyethylenimine (PEI).

16. A method for manufacturing a cellulose-based acetate lined molded fiber article, the method comprising:
positioning the molded fiber article on an open-face suction die with a film-receiving surface of the molded fiber article facing away from the die;
positioning the cellulose-based acetate film adjacent to and facing the film-receiving surface of the molded fiber article;
rapidly preheating the cellulose-based acetate film; and
using suction to cause the preheated cellulose-based acetate film to stretch and contact the film-receiving surface of the molded fiber article, such that the film bonds with one or more contours of the molded fiber article, thereby forming a liner on the film-receiving surface of the molded fiber article.

17. The method of claim 16, additionally comprising preheating the molded fiber article on the die to a preheat temperature after the positioning step.

18. The method of claim 17, wherein preheating the molded fiber article to the preheat temperature is performed via heating the die.

19. The method of claim 17, wherein the preheat temperature of the molded fiber article is within a range of about 300-375° F.

20. The method of claim 16, wherein the suction step, which forms the liner on the molded fiber article, occurs in less than about 1 second.

21. The method of claim 16, wherein the open-face die includes suction ports configured to apply suction through the molded fiber article.

22. The method of claim 21, wherein the suction is applied at about 20 inHg.

23. The method of claim 16 additionally comprising mechanically pressing the film into contact with the film-receiving surface of the molded fiber article via a movable die.

24. The method of claim 16, wherein rapidly preheating the film comprises heating the film to a bonding temperature, wherein the bonding temperature is above both a thermoformable temperature and a crystallization temperature of the film.

25. The method of claim 16, wherein the bonding temperature is within a range of about 350-500° F.

26. The method of claim 16, wherein the rapid preheat time for the film is within a range of about 1-3 seconds.
